(19) United States
(12) Patent Application Publication
(10) Pub. No.: US 2012/0127508 A1
(43) Pub. Date: May 24, 2012

(54) Mechanism for Controlling Secure Print Jobs

(76) Inventor: Robert F. Jessen, Berthoud, CO (US)

(21) Appl. No.: 12/954,513

(22) Filed: Nov. 24, 2010

(51) Int. Cl. G06K 15/02; G06F 3/12

(52) U.S. Cl. 358/1.14; 358/1.18; 358/1.15

(57) ABSTRACT

A computer generated method disclosed. The method includes receiving a print job, processing the print job data stream, determining if a condition occurs during processing of the print job data stream that matches one or more pre-defined criteria and inserting one or more secure print command lines if a condition occurs that matches one or more pre-defined criteria.

### FIELD OF THE INVENTION

The invention relates to the field of printing systems. Particularly, the invention relates to securing confidential print jobs.

### BACKGROUND

Computing centers that employ one or more printers to serve a group of users, such as a networked group or other work group, typically rely on the printers to batch process print jobs (e.g., print-out a series of different print jobs in succession). Often a user of the group needs to print a job at a group printer that includes confidential or sensitive documents. However, in such instances it may be inappropriate to immediately print such a job and have the job placed in a printer output bin where other users may have access. Accordingly, many group printers provide a secure print option.

Secure print enables a user to designate a document as secure prior to printing. In response, the print job instructs the printer to hold the job at the printer with a security number (PIN), rather than immediately printing. The user is then required to physically go to the printer panel and input the PIN number in order to print the document.

However, there are other instances where it would be desirable to designate a print job for secure print without a user having to manually provide the designation. For example, an administrator can enforce a secure print policy.

Accordingly, a mechanism to automate the control of secure print jobs is desired.

### SUMMARY

In one embodiment a computer generated method is disclosed. The method includes receiving a print job, processing the print job data stream, determining if a condition occurs during processing of the print job data stream that matches one or more pre-defined criteria and inserting one or more secure print command lines if a condition occurs that matches one or more pre-defined criteria.

In another embodiment, a print server is disclosed. The print server includes a printing software product to receive a print job, process the print job data stream, determine if a condition occurs during processing of the print job data stream that matches one or more pre-defined criteria and inserts one or more secure print command lines if a condition occurs that matches one or more pre-defined criteria.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 is a flow diagram illustrating one embodiment of automatically producing a secure print jobs; and

FIG. 3 illustrates one embodiment of a computer system.

### DETAILED DESCRIPTION

A mechanism to automatically produce secure print jobs is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

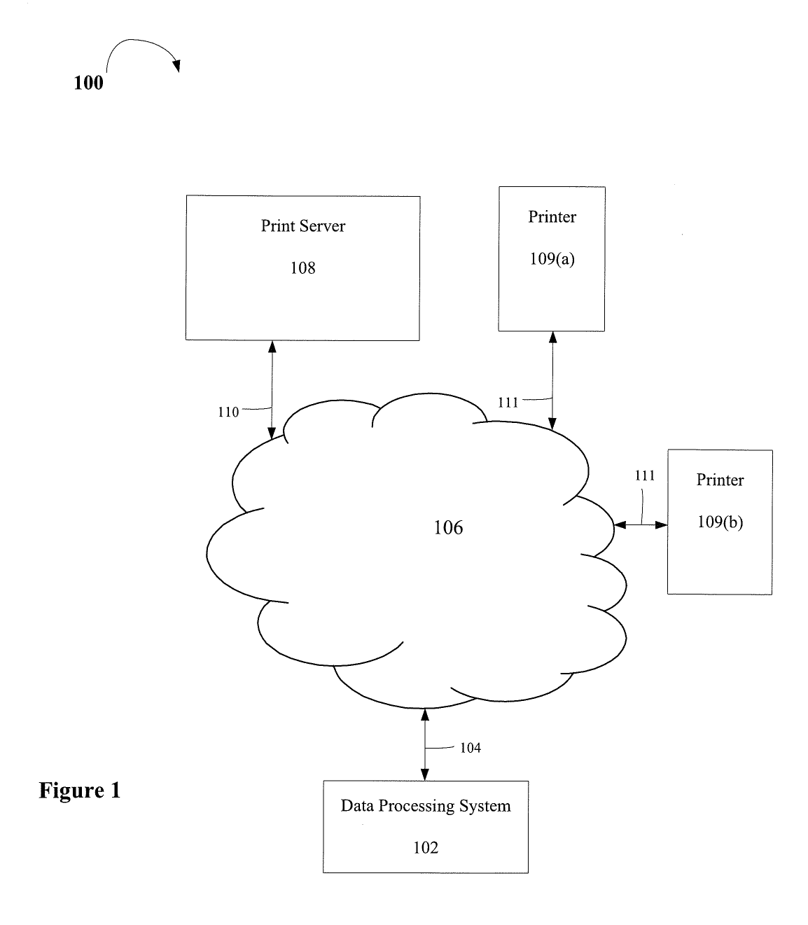

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 100 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

In one embodiment, a print application at data processing system 102 allows a user to select the desired print server 108 and submit requests for service requests to printer 109 via print server 108 over network 106. In other embodiments, additional/alternative presentation architectures (e.g., Printer Job Language (PJL), PostScript, etc.) may be implemented at the print application.

Although described as separate entities, other embodiments may include print server 108 being incorporated in one or more of the printers 109. In yet further embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

According to one embodiment, print server 108 implements a printing software product that manages the printing of documents from data processing system 102 and one or more of printers 109. In other embodiments, the printing software product manages printing of documents from multiple data processing systems 102 to the one or more printers 109. In a further embodiment, the printing software product may be implemented using either InfoPrint Manager (IPM) or InfoPrint ProcessDirector (IPPD), although other types of printing software may be used instead.

In one embodiment, the printing software product processes a print job data stream and determines if a printing condition indicates that the print job is to be printed as a secure print job. In one such embodiment, a condition may be indicated by the print job data stream. Thus, printing software product analyzes the print job data stream against criteria to determine if a print job is to be printed as a secure print job.

Criteria are algorithms or rules that define an action (e.g., insert secure print commands to make the print job secure) upon a data stream matching the criteria. The criteria are pre-defined before a print job is received and may be modified as desired, and may include rules that act on one or more variables.

Additionally, a condition may be indicated by information at printer server 108, resulting in the printing software product analyzing system information against criteria to determine if a print job is to be printed as a secure print job. For instance, system information may include a print job processing schedule (e.g. time, date, day) or selection of a printer 109 (e.g. PRINTER1 or PRINTER2) at print server 108.

In one embodiment, the printing software product searches for and detects the presence of specific print job data stream commands by parsing print job command line arguments and matching them to known commands. In such an embodiment, the printing software product searches for commands within the data stream that indicate that the print job is a secure print job. For instance, these may be PJL commands, such as @PJL SET HOLD=OFF/ON/PROOF/STORE/PRINT, @PJL SET HOLDTYPE=PUBLIC/PRIVATE and @PJL SET HOLDKEY=4 digits PIN, 0000, 1234, . . . 9999. However, other embodiments may implement PostScript commands or other proprietary commands.

Typically, a print job designated as secure includes secure command line arguments to instruct the printer to hold the job at the printer with a PIN number that the user must enter to release it. These secure print jobs are submitted by using command line specific parameters. For instance, the printing software product may insert the proper secure commands into the data stream in response to a secure print request command (e.g., qprt-P ‘queue’-U2-V1234 printfile). Alternatively, the secure commands may be already inserted in the data stream (e.g., PJL SET HOLD=ON; @PJL SET HOLDTYPE=PRIVATE, @PJL SET HOLDKEY=“1234) prior to receipt at the printing software product.

According to one embodiment, the printing software product searches for commands within the data stream that indicate that the print job is directed to a particular printer (e.g. PRINTER1). In another embodiment, the printing software product may select the printer for which the print job is directed by overriding the data stream selected printer (e.g., for printer workload balancing).

In such embodiments, the criteria are set so that print jobs that are specified for the particular printer are designated, and subsequently produced, as secure documents. Accordingly, the printing software product inserts the secure commands into the data stream to instruct the printer to hold the job at the printer with a PIN number. This embodiment may be implemented where the printer administrator has determined that the particular printer is predominately utilized to produce confidential documents or the particular printer is in an insecure location.

In another embodiment, the printing software product searches for commands within the data stream that indicate that the print job is produced by one of a selected group of users. In such an embodiment, the criteria are set so that print jobs that are generated from any members of the group are held as secure documents. This embodiment may be implemented where the printer administrator has determined that the users in the group often produce confidential documents that need to be held.

In yet another embodiment, the printing software product determines the particular period (e.g., time, date, day) that it will process the print job. In such an embodiment, the criteria are set so that print jobs that are processed during that period are held as secure documents. This embodiment may be implemented with the above described printer criterion, where hold commands are inserted into the data stream for all print jobs sent to PRINTER1 between the hours or 5 pm and 7 am. Printers other than PRINTER1 would not be a part of this criteria.

In a further embodiment, the printing software product searches for commands within the data stream that includes printable text indicating that the print job is confidential (e.g. words such as “confidential” or “top secret”). In such an embodiment, the criteria are set such that print jobs including commands using one or more of the pre-defined printable words are held as secure documents.

In still a further embodiment, the printing software product searches for commands within the data stream that indicate the job is already properly secured with commands already inserted in the data stream (e.g., PJL SET HOLD=ON; @PJL SET HOLDTYPE=PRIVATE, @PJL SET HOLDKEY=“1234) prior to receipt at the printing software product. In such an embodiment, there is no need to insert additional secure commands into the data stream. Therefore, the criteria are set such that print jobs including proper secure print commands will not have additional secure commands inserted into the data stream.

One skilled in the art will recognize that various other embodiments may implement additional criteria as an impetus for inserting secure print commands for a print job.

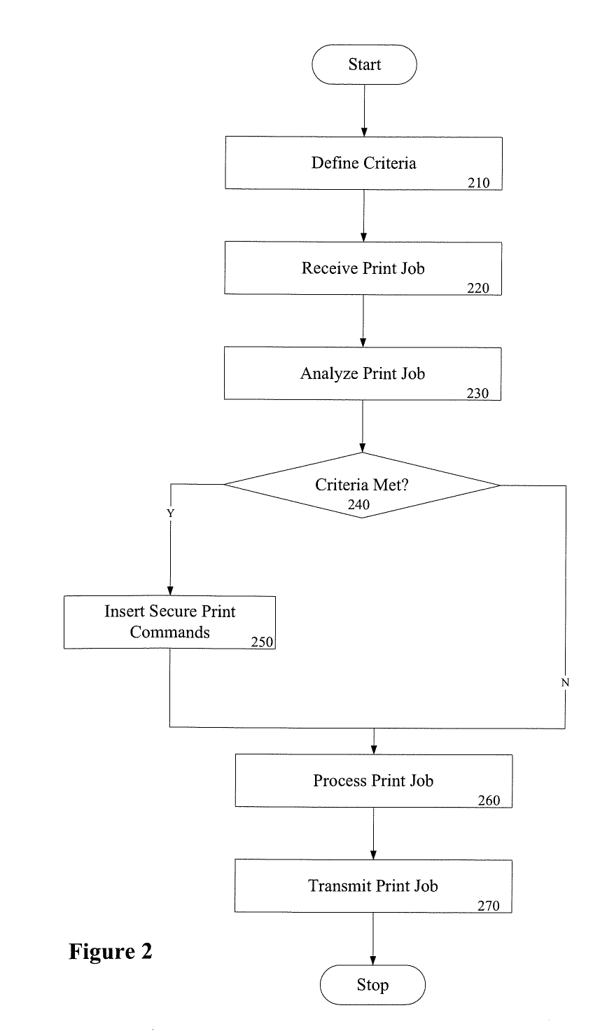

FIG. 2 is a flow diagram illustrating one embodiment of automatically producing secure print jobs. At processing block 210, the criteria are set for which a print job data stream is compared to determine if secure print commands are to be inserted. At processing block 220, a print job data stream is received at the printing software product. At processing block 230, the print job data stream is analyzed. At decision block 240, it is determined whether the data stream and other system information meet the criteria.

If none of the criteria are met the printing software product processes the print job data stream for printing, processing block 260. At processing block 270, the print job is transmitted to a print engine for printing. However if one or more criteria are met, the printing software product inserts the secure print command lines into the data stream prior to processing and transmitting to a print engine, processing block 250.

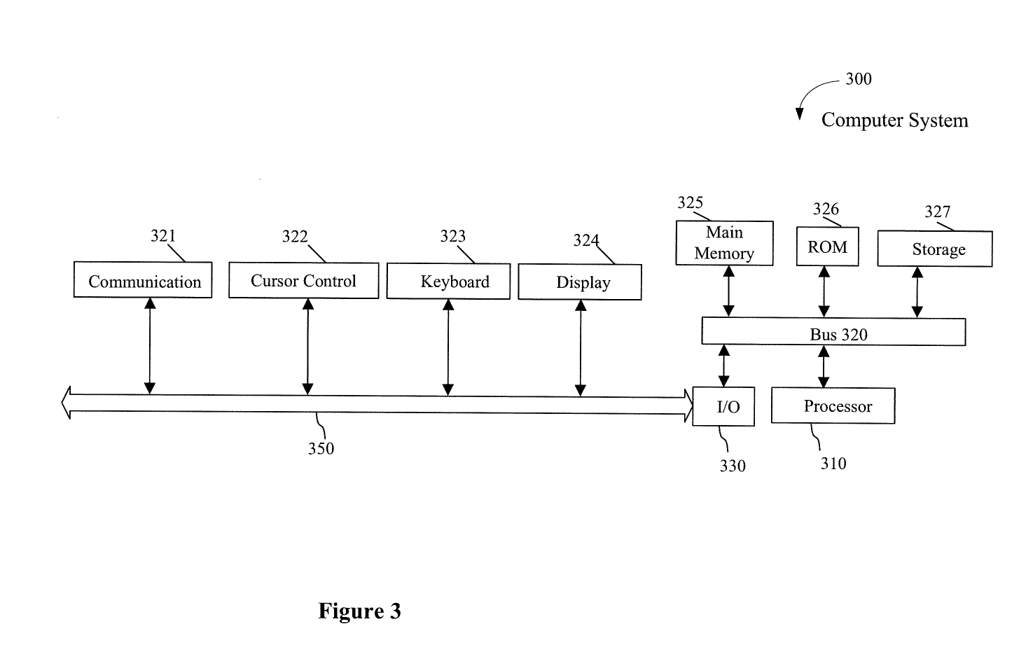

FIG. 3 illustrates a computer system 300 on which data processing system 102 and/or server 108 may be implemented. Computer system 300 includes a system bus 320 for communicating information, and a processor 310 coupled to bus 320 for processing information.

Computer system 300 further comprises a random access memory (RAM) or other dynamic storage device 325 (referred to herein as main memory), coupled to bus 320 for storing information and instructions to be executed by processor 310. Main memory 325 also may be used for storing temporary variables or other intermediate information during execution of instructions by processor 310. Computer system 300 also may include a read only memory (ROM) and or other static storage device 326 coupled to bus 320 for storing static information and instructions used by processor 310.

A data storage device 325 such as a magnetic disk or optical disc and its corresponding drive may also be coupled to computer system 300 for storing information and instructions. Computer system 300 can also be coupled to a second I/O bus 350 via an I/O interface 330. A plurality of I/O devices may be coupled to I/O bus 350, including a display device 324, an input device (e.g., an alphanumeric input device 323 and or a cursor control device 322). The communication device 321 is for accessing other computers (servers or clients). The communication device 321 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer generated method comprising:
receiving a print job;
processing the print job data stream;
determining if a condition occurs during processing of the print job data stream that matches one or more pre-defined criteria; and
inserting one or more secure print command lines if a condition occurs that matches one or more pre-defined criteria.

2. The method of claim 1 wherein the condition comprises a data stream command that matches one or more of the pre-defined criteria.

3. The method of claim 1 wherein the condition comprises system information that matches one or more pre-defined criteria.

4. The method of claim 1 further comprising transmitting the print job to a printer.

5. The method of claim 4 wherein the secure print command lines instruct the printer to hold the print job.

6. The method of claim 4 further comprising:
prompting a user for security number at the printer, and
printing the print job upon the user entering the security number.

7. The method of claim 1 further comprising processing the print job without inserting the one or more secure print command lines if a condition does not match one or more pre-defined criteria.

8. The method of claim 7 further comprising:
transmitting the print job to a print engine; and
printing the print job.

9. The method of claim 1 wherein a criteria is an indication that a print job is to be directed to a specified printer and the one or more secure print command lines are inserted if the print job is to be directed to the specified printer.

10. The method of claim 1 wherein a criteria is an indication that a print job has been generated by a specified user and the one or more secure print command lines are inserted if the print job data stream includes a command indicating that the print job has been generated by the specified user.

11. The method of claim 1 wherein a criteria is an indication that a print job has been processed during a predefined time window and the one or more secure print command lines are inserted if the print job has been processed during the time window.

12. A print server comprising a printing software product to receive a print job, process the print job data stream, determine if a condition occurs during processing of the print job data stream that matches one or more pre-defined criteria and inserts one or more secure print command lines if a condition occurs that matches one or more pre-defined criteria.

13. The print server of claim 12 wherein the condition comprises a data stream command that matches one or more of the pre-defined criteria.

14. The print server of claim 13 wherein the condition comprises system information that matches one or more pre-defined criteria.

15. The print server of claim 12 wherein a criteria is an indication that a print job is to be directed to a specified printer and the printing software product inserts the one or more secure print command lines if the print job is to be directed to the specified printer.

16. The print server of claim 12 wherein a criteria is an indication that a print job has been generated by a specified user and the printing software product inserts the one or more secure print command lines if the print job data stream includes a command indicating that the print job has been generated by the specified user.

17. The print server of claim 12 wherein a criteria is an indication that a print job has been processed during a predefined time window and the printing software product inserts the one or more secure print command lines if the print job has been processed during the time window.

18. An article of manufacture comprising a machine-readable medium including data that, when accessed by a machine, cause the machine to perform operations comprising:
receiving a print job;
processing the print job data stream;
determining if a condition occurs during processing of the print job data stream that matches one or more pre-defined criteria; and
inserting one or more secure print command lines if a condition occurs that matches one or more pre-defined criteria.

19. The article of manufacture of claim 18 wherein a criteria is an indication that a print job is to be directed to a specified printer and the one or more secure print command lines are inserted if the print job is to be directed to the specified printer.

20. The article of manufacture of claim 18 wherein a criteria is an indication that a print job has been generated by a specified user and the one or more secure print command lines are inserted if the print job data stream includes a command indicating that the print job has been generated by the specified user.
